(19) United States
(12) Patent Application Publication
(10) Pub. No.: US 2007/0182697 A1
(43) Pub. Date: Aug. 9, 2007

(54) Backlight module driving circuit

(75) Inventors: Shu-Ming Chang, Hsinhua (TW); Yu-Pei Huang, Hsinhua (TW); Shen-Yao Liang, Hsinhua (TW); Shwang-Shi Bai, Hsinhua (TW)

Correspondence Address: THE WEBB LAW FIRM, P.C., 700 KOPPERS BUILDING, 436 SEVENTH AVENUE, PITTSBURGH, PA, 15219, US

(73) Assignee: HIMAX TECHNOLOGIES, INC., Hsinhua (TW)

(21) Appl. No.: 11/509,500

(22) Filed: Aug. 24, 2006

(30) Foreign Application Priority Data
Feb. 7, 2006 (TW) 95101084

(51) Int. Cl. G09G 3/36

(52) U.S. Cl. 345/102

(57) ABSTRACT

A backlight driver circuit has a transformer, a switching circuit and a plurality of switch devices. The switching circuit couples a DC voltage to a primary side of the transformer and alternates polarities thereof so that an AC voltage is generated on a secondary side of the transformer to turn on the backlight blocks. The switch devices are respectively connected between one of the backlight blocks and the transformer, and the AC voltage turns the backlight blocks on when the switch devices are turned on.

### RELATED APPLICATIONS

The present application is based on, and claims priority from, Taiwan Application Serial Number 95104084, filed Feb. 7, 2006, the disclosure of which is hereby incorporated by reference herein in its entirety.

### BACKGROUND

1. Field of Invention

The present invention relates to a driver circuit. More particularly, the present invention relates to a driver circuit used to turn on the backlight module of a liquid crystal display (LCD).

2. Description of Related Art

FIG. 1 shows the framework of an LCD 100. The LCD 100 comprises a pixel array 102 and a backlight module 104. The pixel array 102 and the backlight module 104 are stacked against each other, but they are separately disposed in FIG. 1 to be illustrated more clearly. The pixel array 102 comprises several pixel structures, and the backlight module 104 comprises several parallel cold cathode fluorescent lamps (CCFL) 106.

Generally, a scan-backlight control mode is used to display images for improving the quality of dynamic images. The whole pixel array 102 is divided into several display blocks, that is, display blocks 102a-102d. Similarly, the whole backlight module 104 is also divided into several backlight blocks 104a-104d that correspond to the display blocks 102a-102d positions. Each of the backlight blocks 104a-104d comprises at least one of the CCFLs 106. In the scan-backlight control mode, the display blocks 102a-102d are driven and charged according to a specific sequence. At the same time, the backlight blocks 104a-104d corresponding to the display blocks 102a-102d are also turned on according to the same sequence for displaying a complete image.

Thus, the CCFLs 106 in the backlight module 104 are respectively turned on and off based on blocks of CCFLs 106 rather than being turned on and off at the same time, and the amount of the backlight driver units will increase when the amount of the backlight blocks increases. FIG. 2 shows a driver circuit 200 for cooperating with the backlight module 104 shown in FIG. 1. It can be seen that each backlight block (104a, 104b, 104c, 104d) is driven by one switching circuit (204a, 204b, 204c, 204d) and one transformer (206a, 206b, 206c, 206d). The switching circuits 204a-204d are powered by a DC power supply 202. When one of the backlight blocks needs to be turned on, the switching circuit corresponding to the backlight block should be enabled.

Some problems can be seen from the framework of the driver circuit 200. For example, if there are too many units, such as switching circuits and transformers, in the driver circuit 200, the weight and volume of the flat panel display will be substantially increased, and the circuit will become more complicated. In addition, a great quantity of the switching circuits usually accompanies a great quantity of the switching motions, and the power consumed will be substantial. These problems will become obstacles for the development of LCD displays, and especially for small size LCD displays.

### SUMMARY

It is therefore an objective of the present invention to provide a backlight module driver circuit used in a LCD.

It is another objective of the present invention to provide a backlight module driver circuit with less electronic units.

It is still another objective of the present invention to provide a smaller and lighter backlight module driver circuit.

It is still another objective of the present invention to provide a backlight module driver circuit with less power consumption.

According to one preferred embodiment, the backlight driver circuit comprises a transformer, a switching circuit and a plurality of switch devices. The switching circuit couples a DC voltage to a primary side of the transformer and alternates polarities thereof so that an AC voltage is generated on a secondary side of the transformer to turn on the backlight blocks. The switch devices are respectively connected between one of the backlight blocks and the transformer, and the AC voltage turns the backlight blocks on when the switch devices are turned on.

According to another preferred embodiment, the backlight driver circuit comprises a plurality of transformers, a switching circuit and a plurality of switch devices. The switching circuit couples a DC voltage to primary sides of the transformers and alternates polarities thereof so that an AC voltage is generated on secondary sides of the transformers to turn on the backlight blocks. The switch devices are respectively connected to the transformers, and the switch devices are used to determine whether the backlight blocks are turned on. When one of the switch devices is turned on, the transformer connected to the turned-on switch device outputs the AC voltage to turn on one of the backlight blocks.

According to another preferred embodiment, the flat display panel comprises a pixel array, a backlight module and a backlight module driver circuit. The pixel array comprises a plurality of display blocks. The backlight module comprises a plurality of backlight blocks, and the backlight blocks correspond the display blocks in position. The backlight module driver circuit is used to turn on the backlight blocks.

The backlight module driver circuit comprises a transformer, a switching circuit and a plurality of switch devices. The switching circuit couples a DC voltage to a primary side of the transformer and alternates polarities thereof so that an AC voltage is generated on a secondary side of the transformer to turn on the backlight blocks. The switch devices are respectively connected between one of the backlight blocks and the transformer, and the switch devices are used to determine whether the backlight blocks are turned on. When one of the switch devices is turned on, the backlight block connected to the turned-on switch device is turned on by the AC voltage.

### BRIEF DESCRIPTION OF THE DRAWINGS

These and other features, aspects and advantages of the present invention will become better understood with regard to the following description, appended claims and accompanying drawings, where:

FIG. 1 shows the framework of a conventional LCD;

FIG. 2 shows the framework of the backlight module driver circuit used in the conventional LCD;

FIG. 3A shows the framework of a backlight module driver circuit according to one embodiment;

FIG. 3B shows the circuit diagram of the backlight module driver circuit;

FIG. 4 shows the framework of a backlight module driver circuit according to another embodiment; and

FIG. 5 shows the framework of a backlight module driver circuit according to another embodiment.

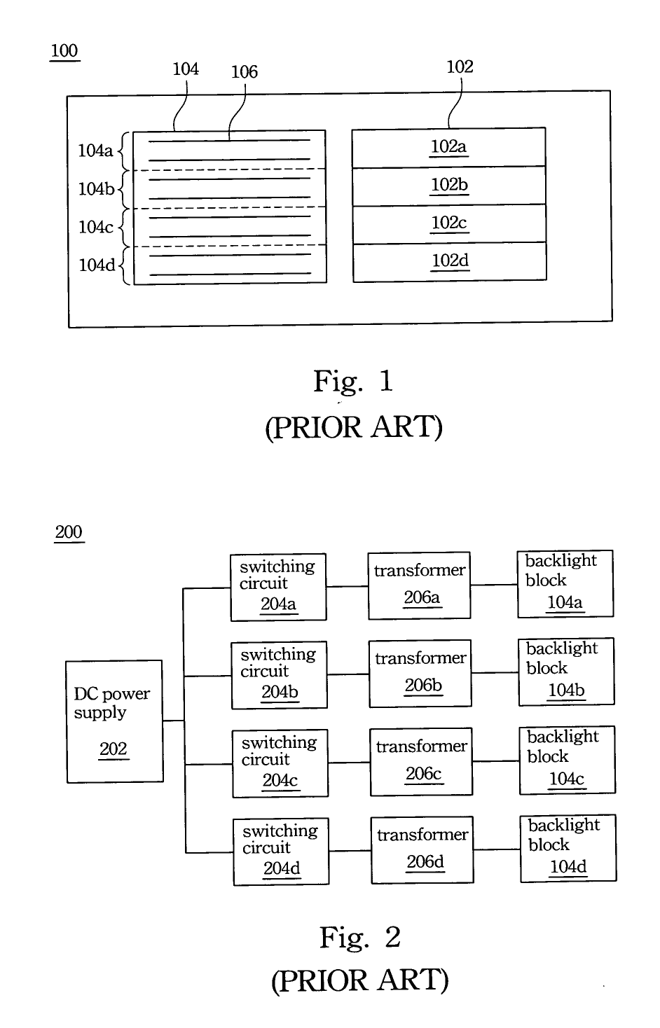

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the descriptions to refer to the same or like parts.

The scan-backlight control mode can be used to improve the quality of the image displayed on a LCD display. Therefore, each of the backlight blocks of the backlight module should cooperate with a driver unit, such as a switching circuit and a transformer, to implement the scan-backlight control mode in a conventional LCD, and the driver unit is able to turn on one of the backlight blocks it connects to. Thus, all of the electronic elements, the volume, the weight and the cost of the backlight module substantially increase. The basic concept of the present invention is to use less driver units to turn on more backlight blocks, and a switch device is used to determine which backlight block is turned on.

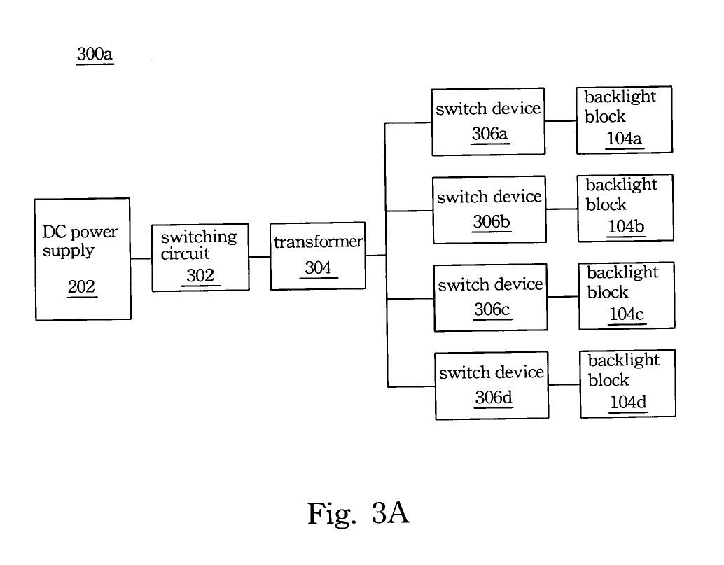

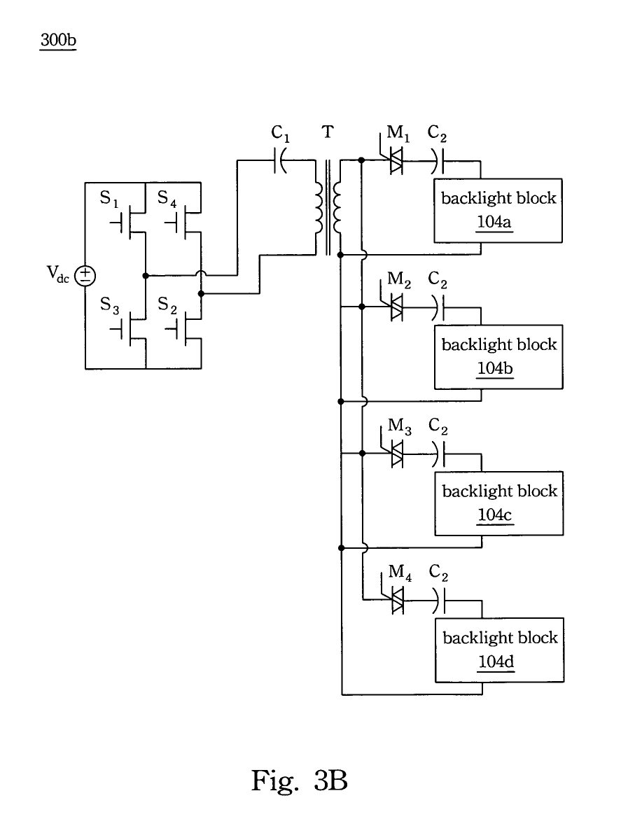

FIG. 3A shows framework 300a of a backlight module driver circuit according to an embodiment of the present invention. In FIG. 3A the backlight module driver circuit 300a has a switching circuit 302, a transformer 304 and switch device 306a-306d. The framework 300a is used in a flat panel display, such as a LCD display, and one of the purposes of the framework 300a is to respectively turn on backlight blocks 104a-104d included in the backlight module of the flat panel display.

In general, each of the backlight blocks 104a-104d includes several cold cathode fluorescent lamps (CCFLs) to be light sources, and the CCFLs should be powered by AC voltage. Hence, the switching circuit 302 couples a DC voltage to a primary side of the transformer 304 and alternating polarities thereof so that an AC voltage is generated on a secondary side of the transformer 304 to turn on the backlight blocks 104a-104d.

The AC voltage output from the transformer 304 is used to turn on all the backlight blocks 104a-104d in this embodiment. That is, all the backlight blocks can be turned on by only one driver unit, i.e. the switching circuit 302 and the transformer 304, and the amount of driver units can thus be effectively reduced. The backlight blocks 104a-104d are not turned on and off at the same time under the scan-backlight mode; therefore, switch devices 306a-306d are used to turn the backlight blocks 104a-104d on and off, respectively. The switch devices 306a-306d are respectively disposed between each of the backlight blocks 104a-104d and the transformer 304. For example, the two ends of the switch device 306a are respectively connected to the transformer 304 and the backlight block 104a. When the switch device 306a is tuned on, the backlight block 104a is turned on. Similarly, the switch devices 306b-306d are used to turn the backlight blocks 104b-104d on and off respectively.

FIG. 3B shows a backlight module driver circuit 300b used to implement the framework 300a shown in FIG. 3A. Referring to FIGS. 3A and 3B, it can be seen that inverting switches S1-S4, such as MOSFETs, are used to implement the switching circuit 302, a transformer T is used to implement the transformer 304, and triacs M1-M4 are used to implement switch devices 306a-306d. The inverting switch S1 and S3 cascade with each other and is then parallel with a DC power supply Vdc, and the inverting switch S2 and S4 cascade with each other and is then parallel with the DC power supply Vdc also. In the primary side of the transformer T, one endis connected to the contact between the inverting switch S1 and S3, and the other endis connected to the contact between the inverting switch S2 and S4. Assuming the inverting switch S1 and S2 is a switch set, and the inverting switch S3 and S4 is another switch set, when the two switch sets are quickly and alternately switched, an AC voltage used to turn on the backlight blocks 104a-104d is thus generated at the secondary side of the transformer T.

In this embodiment, the triacs M1-M4 are respectively cascaded between the secondary side of the transformer T and each of the backlight blocks 104a-104d, and are used to respectively turn the backlight blocks 104a-104d on and off. Other kind of controllable two-way conducting devices may be used instead of the triacs M1-M4. According to the foregoing description, when the triac M1 is turned on, the AC voltage generated at the secondary side of the transformer T turns the backlight block 104a on. Similarly, the triacs M2-M4 are used to turn the backlight blocks 104b-104d on and off respectively. Furthermore, capacities C1 and C2 may be respectively cascaded with the primary side and the secondary side of the transformer T for blocking the DC portion in the AC voltage.

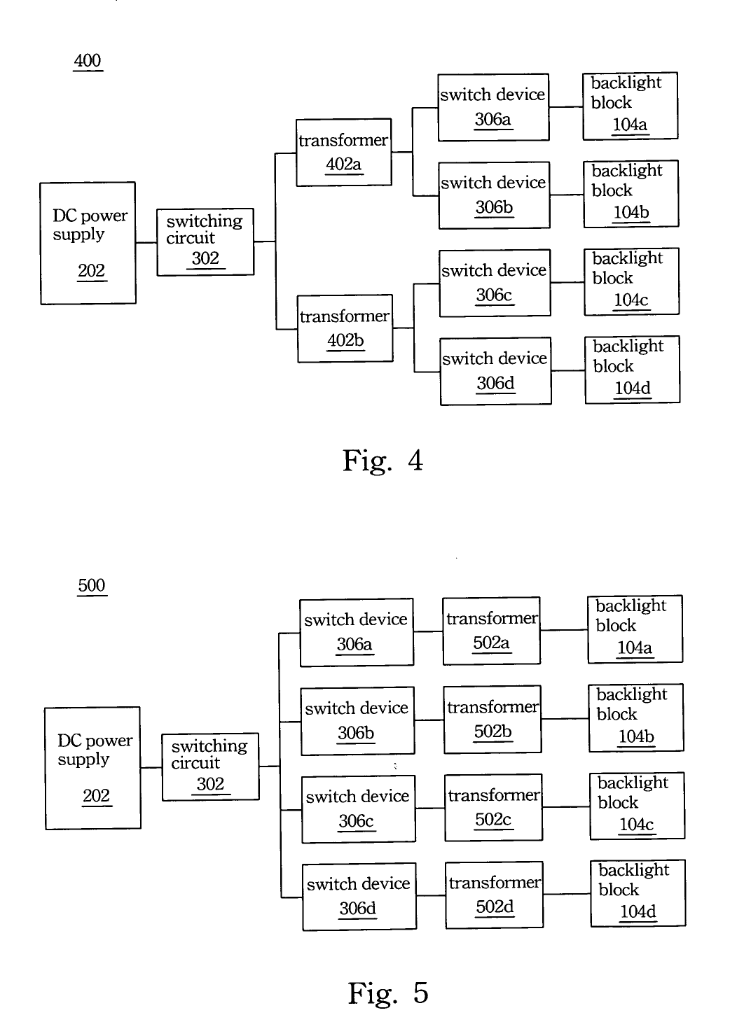

Giving consideration to the capacity limitations of a transformer, the AC voltages for different backlight blocks may be respectively provided by different transformers. FIG. 4 shows a framework 400 of a backlight module driver circuit according to another embodiment of the present invention. The framework 400 has a switching circuit 302, transformers 402a and 402b, and switch devices 306a-306d. In this embodiment, the AC voltage output from the transformer 402a is used to turn on the backlight blocks 104a and 104b, and the AC voltage output from the transformer 402b is used to turn the backlight blocks 104c and 104d on. The embodiment uses one switching circuit 302 and two transformers 402a and 402b. Thus, even though the framework 400 has one more transformer than the framework 300a shown in FIG. 3A, the capacity of both the transformers 402a and 402b can be smaller than the transformer 304 shown in FIG. 3A.

The switch devices 306a-306d are also used to turn the backlight blocks on and off respectively. The switch device 306a is disposed between the backlight block 104a and the transformer 402a, the switch device 306b is disposed between the backlight block 104b and the transformer 402a, the switch device 306c is disposed between the backlight block 104c and the transformer 402b, and the switch device 306d is disposed between the backlight block 104d and the transformer 402b. For example, the two ends of the switch device 306a are respectively connected to the transformer 402a and the backlight block 104a. When the switch device 306a is turned on, the backlight block 104a can be turned on by the AC voltage output from the transformer 402a. Similarly, switch devices 306b-306d are used to turn the backlight blocks 104b-104d on and off respectively, but the AC voltage of the backlight blocks 104c and 104d is output from the transformer 402b.

Similarly, the operation of the switching circuit 302 can be implemented by quickly switching several inverting switches in this embodiment. The switch devices 306a-306d may be triacs or other kind of controllable two-way conducting devices. Capacitors used to block the DC portion may be disposed on the primary side and the secondary side of the transformers 402a and 402b.

In the frameworks 300a and 400 respectively shown in FIGS. 3A and 4, the switch devices 306a-306d are respectively disposed on the secondary side of the transformers 304, 402a and 402b. But the switch devices may be disposed on the primary side of the transformers when the amount of transformers is identical to the amount of backlight blocks in the driver circuit framework. For example, the backlight module driver circuit framework 500 shown in FIG. 5. The framework 500 has a switching circuit 302, transformers 502a-502d and switch devices 306a-306d. The amount of transformers and the amount of backlight blocks in the framework 500 are identical, that is, the AC voltage output from the transformers 502a-502d are respectively used to turn the backlight blocks 104a-104d on. The driver unit in this embodiment has one switching circuit (the switching circuit 302) and four transformers (the transformers 502a-502d). Although the framework 500 has more transformers than the other circuit, the capacity of the transformers 502a-502d can be smaller.

The switch devices 306a-306d are also used to respectively turn the backlight blocks 104a-104d on and off. But in this embodiment, the switch devices 306a-306d are respectively disposed between each of the transformers 502a-502d and the switching circuit 302 to respectively enable and disable the transformers 502a-502d. For example, the two ends of the switch device 306a are respectively connected to the switching circuit 302 and the transformer 502a. When the switch device 306a is turned on, the backlight block 104a can be turned on by the AC voltage output from the transformer 502a. Similarly, The switch devices 306b-306d are used to enable and disable the transformer 502b-502d respectively, and the backlight blocks 104b-104d can be further turned on and off.

Similarly, the operation of the switching circuit 302 can be implemented by quickly switching several inverting switches in this embodiment. The switch devices 306a-306d may be triacs or other kind of controllable two-way conducting devices. Capacitors used to block the DC portion may be disposed on the primary side and the secondary side of the transformers 502a-502d.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module driver circuit used to turn on a plurality of backlight blocks in a backlight module, the backlight driver circuit comprising:
a transformer;
a switching circuit coupling a DC voltage to a primary side of the transformer and alternating polarities thereof so that an AC voltage is generated on a secondary side of the transformer to turn on the backlight blocks; and
a plurality of switch devices respectively connected between one of the backlight blocks and the transformer, and the AC voltage turns the backlight blocks on when the switch devices are turned on.

2. The backlight module driver circuit as claimed in claim 1, wherein the switch devices are not turned on and off at the same time.

3. The backlight module driver circuit as claimed in claim 1, wherein the switching circuit comprises two sets of inverting switches, and the polarities of the DC voltage are alternated by alternately switching between the two sets of inverting switches.

4. The backlight module driver circuit as claimed in claim 3, wherein the two sets of inverting switches comprise a plurality of MOSFETs.

5. The backlight module driver circuit as claimed in claim 1, wherein the switch devices are triacs.

6. The backlight module driver circuit as claimed in claim 1, further comprising a plurality of capacitors respectively disposed on the primary side and the secondary side of the transformer, wherein the capacitors are used to block the DC portion of the AC voltage.

7. A backlight module driver circuit used to turn on a plurality of backlight blocks in a backlight module, the backlight driver circuit comprising:
a plurality of transformers;
a switching circuit coupling a DC voltage to primary sides of the transformers and alternating polarities thereof so that an AC voltage is generated on secondary sides of the transformers to turn on the backlight blocks; and
a plurality of switch devices respectively connected to the transformers, and the switch devices are used to determine whether the backlight blocks are turned on,
wherein when one of the switch devices is turned on, the transformer connected to the turned-on switch device outputs the AC voltage to turn on one of the backlight blocks.

8. The backlight module driver circuit as claimed in claim 7, wherein the switch devices are respectively disposed between the switching circuit and one of the transformers, when the switch devices are turned on, the transformers are enabled to output the AC voltage to turn on the backlight blocks.

9. The backlight module driver circuit as claimed in claim 7, wherein the switch devices are respectively disposed between one of the transformers and one of the backlight blocks, when the switch devices are turned on, the transformers output the AC voltage to turn on the backlight blocks.

10. The backlight module driver circuit as claimed in claim 7, wherein the switch devices are not turned on and off at the same time.

11. The backlight module driver circuit as claimed in claim 7, wherein the switching circuit comprises two sets of inverting switches, and the polarities of the DC voltage are alternated by alternately switching the two sets of inverting switches.

12. The backlight module driver circuit as claimed in claim 11, wherein the two sets of inverting switches comprise a plurality of MOSFETs.

13. The backlight module driver circuit as claimed in claim 7, wherein the switch devices are triacs.

14. The backlight module driver circuit as claimed in claim 7, further comprising a plurality of capacitors respectively disposed at the primary side and the secondary side of the transformers, wherein the capacitors are used to block the DC portion of the AC voltage.

15. A flat display panel, comprising:
a pixel array comprising a plurality of display blocks;
a backlight module comprising a plurality of backlight blocks, wherein the backlight blocks correspond the display blocks in position; and
a backlight module driver circuit used to turn on the backlight blocks, the backlight module driver circuit comprising:
a transformer;
a switching circuit coupling a DC voltage to a primary side of the transformer and alternating polarities thereof so that an AC voltage is generated on a secondary side of the transformer to turn on the backlight blocks; and
a plurality of switch devices respectively connected between one of the backlight blocks and the transformer, and the switch devices are used to determine whether the backlight blocks are turned on, wherein when one of the switch devices is turned on, the backlight block connected to the turned-on switch device is turned on by the AC voltage.

16. The flat display panel as claimed in claim 15, wherein the switch devices are not turned on and off at the same time.

17. The flat display panel as claimed in claim 15, wherein the switching circuit comprises two sets of inverting switches, and the polarities of the DC voltage are alternated by alternately switching the two sets of inverting switches.

18. The flat display panel as claimed in claim 17, wherein the two sets of inverting switches comprise a plurality of MOSFETs.

19. The flat display panel as claimed in claim 15, wherein the switch devices are triacs.

20. The flat display panel as claimed in claim 15, further comprising a plurality of capacitors respectively disposed on the primary side and the secondary side of the transformer, wherein the capacitors are used to block the DC portion of the AC voltage.
